(19) United States
(12) Patent Application Publication
(10) Pub. No.: US 2004/0015941 A1
(43) Pub. Date: Jan. 22, 2004

(54) Information-processing apparatus equipped with nonvolatile memory device and firmware-updating method for use in the apparatus

(75) Inventor: Norihisa Sekine, Ome-shi (JP)

Correspondence Address: David A. Blumenthal, FOLEY & LARDNER, 35th Floor, 2029 Century Park East, Los Angeles, CA, 90067-3021, US

(73) Assignee: KABUSHIKI KAISHA TOSHIBA

(21) Appl. No.: 10/021,609

(22) Filed: Dec. 12, 2001

(30) Foreign Application Priority Data
Feb. 15, 2001 (JP) 2001-038941

(51) Int. Cl. G06F 9/445; G06F 15/177

(52) U.S. Cl. 717/168; 713/2; 713/300

(57) ABSTRACT

An information-processing apparatus includes a nonvolatile memory device configured to store firmware. The information-processing apparatus has a first unit for issuing an instruction to make an operating system execute a shutdown process, and to update the firmware, stored in the nonvolatile memory device, after the operating system has completed the shutdown process. The information-processing apparatus also has a second unit, responsive to the instruction to update the firmware, for updating the firmware only after the operating system has completed the shutdown process.

### CROSS-REFERENCE TO RELATED APPLICATIONS

This application is based upon and claims the benefit of priority from the prior Japanese Patent Application No. 2001-038941, filed Feb. 15, 2001, the entire contents of which are incorporated herein by reference.

### BACKGROUND OF THE INVENTION

1. Field of the Invention

The present invention relates to an information-processing apparatus equipped with a nonvolatile memory device, such as a personal computer, and a firmware-updating method for updating firmware, such as a BIOS program, stored in the nonvolatile memory device.

2. Description of the Related Art

Various types of notebook-sized portable personal computers that can be powered by a battery have been recently developed. These personal computers contain an electrically programmable nonvolatile memory device such as a flash memory. The nonvolatile memory device stores the BIOS (Basic Input Output System). Since the nonvolatile memory device is electrically programmable, the BIOS contained therein can be easily updated into a new version.

In personal computers, the updating of the BIOS generally requires a flexible disk (FD) that stores a BIOS image file for a new version, and a BIOS-updating system program for the updating of the BIOS. The flexible disk is inserted into the personal computer. The computer is then powered on. Thus, the computer is booted up from the flexible disk, thereby executing the BIOS-updating system program. This BIOS-updating system program rewrites the contents of the nonvolatile memory device using the BIOS image file, thereby updating the BIOS into a new version.

The reason why the system is booted up from the FD is that if the BIOS updating process is executed while a program other than the BIOS-updating system program is being executed, it is possible that the BIOS will not be written correctly.

Specifically, in general, while the operating system (OS) is running, various types of software such as applications and drivers, etc. are operating. If a function call is generated by such software to the BIOS while the BIOS updating process is executed, there is the danger of the execution of an access to an address space assigned to the nonvolatile memory device that stores the BIOS. In this case, the BIOS cannot be updated normally and further, the contents of the nonvolatile memory device may be erroneously damaged, thereby making the currently used BIOS completely inoperable. To avoid such a problem, it is necessary to boot up the system using an FD on which is stored the BIOS-updating system program.

Many recent personal computers, however, have come to employ a so-called FDD-less system structure, not equipped with a floppy disk drive (FDD), in order to enhance their portability. These personal computers cannot employ the method of booting up themselves using an FD.

Thus, a method and apparatus for updating firmware such as the BIOS and control programs without the use of a floppy disk and FFD is highly desirable.

### BRIEF SUMMARY OF THE INVENTION

According to embodiments of the invention, there is provided an information-processing apparatus capable of updating, in a more reliable manner, firmware such as a BIOS or a control program for a controller stored in a nonvolatile memory device, and a firmware-updating method for use in the information-processing apparatus.

According to embodiments of the invention, there is provided an information-processing apparatus having a nonvolatile memory device configured to store firmware; a first device for issuing an instruction to an operating system to make the operating system execute a shutdown process, and to update the firmware, stored in the nonvolatile memory device, after the operating system has completed the shutdown process; and second device, responsive to the instruction to update the firmware, for updating the firmware after the operating system has completed the shutdown process.

According to other embodiments of the invention, there is provided an information-processing apparatus capable of executing various types of programs, and having a nonvolatile memory device configured to store firmware; a first device for issuing, to an operating system, a shutdown request containing a request for updating the firmware, thereby making the operating system execute a shutdown process, and also causing the operating system to issue, after the operating system has completed the shutdown process, a power management event including an instruction to update the firmware stored in the nonvolatile memory device and to power off or reboot the information-processing apparatus; and a second device, responsive to the power management event issued from the operating system, for executing a firmware-updating process to update the firmware stored in the nonvolatile memory device thereby providing new firmware, and then powering off or rebooting the information-processing apparatus.

In according with other embodiments of the invention, there is provided an information-processing apparatus capable of executing various types of programs. The apparatus has a nonvolatile memory device configured to store firmware; a firmware-updating device for updating the firmware stored in the nonvolatile memory device; and a device for instructing, when updating the firmware, the firmware-updating device to update the firmware, using a power management event that is issued from an operating system being executed in the information-processing apparatus, the power management event causing initiation and completion of a shutdown process, then an updating of the firmware and lastly a powering off or rebooting of the information processing system.

Embodiments of the invention may also be characterized as a firmware-updating method of updating firmware executed in an information-processing apparatus. The method includes the steps of making an operating system execute a shutdown process, and issuing an instruction to update firmware stored in a nonvolatile memory device incorporated in the information-processing apparatus, after the operating system has completed the shutdown process; and updating the firmware after the operating system has completed the shutdown process, in response to the instruction to update the firmware.

Further embodiments of the invention are directed toward a firmware-updating method of updating firmware executed in an information-processing apparatus, comprising issuing, to an operating system, a shutdown request containing a request for updating the firmware stored in a nonvolatile memory device provided in the information-processing apparatus, thereby making the operating system execute a shutdown process, and also causing the operating system to issue, after the operating system has completed the shutdown process, a power management event as an instruction to update the firmware and to power off or reboot the information-processing apparatus; and executing a firmware-updating process to update the firmware into new firmware, in response to the power management event issued from the operating system when the operating system has completed the shutdown process, and then powering off or rebooting the information-processing apparatus.

Yet additional embodiments of the invention may be characterized as a program stored in a storage medium and operable, when executed on a computer to cause said computer to execute a firmware-updating process for updating of firmware in the computer. The program causes the computer to perform the steps of:

receiving a firmware-updating request for updating the firmware, which is issued from an operating system when the operating system has executed a shutdown process on the computer; and executing a firmware-updating process for updating, into new firmware, the firmware stored in a nonvolatile memory device provided in the computer, after the operating system has completed the shutdown process.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiment given below, serve to explain the principles of the invention.

FIG. 1 is a block diagram illustrating an information-processing apparatus according to an embodiment of the present invention;

FIG. 2 is a block diagram illustrating a software structure that realizes a firmware-updating method executed in the information-processing apparatus of the embodiment;

FIG. 3 is a view useful in explaining a firmware-updating process executed in the information-processing apparatus of the embodiment;

FIG. 4 is a flowchart useful in explaining the procedure of a firmware-updating application executed in the information-processing apparatus of the embodiment;

FIG. 5 is a flowchart useful in explaining the procedure of an operating system executed in the information-processing apparatus of the embodiment;

FIG. 6 is a flowchart useful in explaining a procedure of a BIOS executed in the information-processing apparatus of the embodiment;

FIG. 7 is a flowchart useful in explaining the procedure of a firmware-updating program executed in the information-processing apparatus of the embodiment;

FIG. 8 is a view illustrating an example structure of a new firmware data package downloaded and used in the information-processing apparatus of the embodiment;

FIG. 9 is a view illustrating the activation of a firmware-updating program included in the new firmware data package shown in FIG. 8;

FIG. 10 is a view illustrating a structure of new firmware data used in the embodiment, and an example of attribute information to be attached thereto;

FIG. 11 is a view illustrating a structure of new firmware data used in the embodiment, and another example of attribute information to be attached thereto; and

FIG. 12 is a flowchart useful in explaining another procedure of the BIOS executed in the information-processing apparatus of the embodiment.

### DETAILED DESCRIPTION OF THE INVENTION

An embodiment of the present invention will be described with reference to the accompanying drawings.

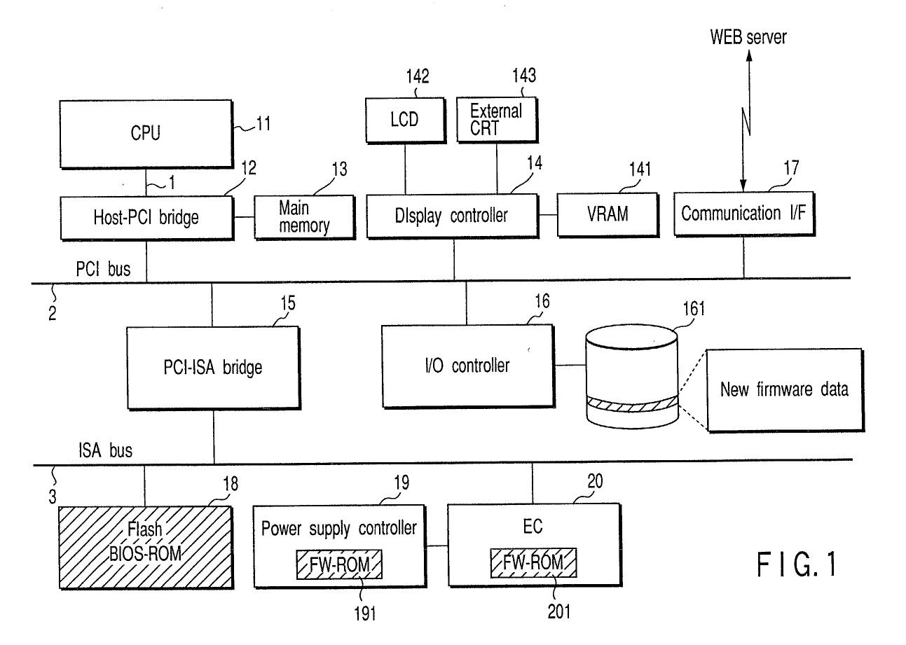

FIG. 1 shows a structure of an information-processing apparatus according to the embodiment of the invention. This embodiment employs, as an example of the information-processing apparatus, a notebook-type personal computer that can be powered by a battery. As shown, the main body of the computer comprises a processor bus 1, a PCI bus 2, an ISA bus 3, a CPU 11, a host-PCI bridge 12, a main memory 13, a display controller 14, a PCI-ISA bridge 15, an I/O controller 16, a communication interface 17, a flash BIOS-ROM 18, a power supply controller 19 and an embedded controller (EC) 20.

The CPU 11 is configured to control the operation of the computer. The CPU 11 executes a system BIOS (Basic Input Output System) stored in the BIOS-ROM 18, an operating system (OS) and other various types of programs loaded in the main memory 13. The system of the embodiment employs a firmware-updating application and a firmware-updating program, which are used as software for rewriting firmware such as the system BIOS stored in the BIOS-ROM 18, a control program for the power supply controller 19 and a control program for the EC 20. When updating the firmware, the CPU 11 executes the firmware-updating application and the firmware-updating program. The firmware-updating application is configured to operate in an environment in which the operating system (OS) is operating, while the firmware-updating program is configured to be a program that does not require the operating system (OS) when it is executed.

The updating process of the firmware is started when the firmware-updating application has issued, to the operating system (OS), a request for shutdown to update the firmware. A firmware-updating process is executed after the completion of the shutdown process by the operating system (OS), i.e. in a state in which the operating system and all the software operable thereon stop their operations. During the operation of the OS, various types of applications and/or drivers are operating. Therefore, if a call for the BIOS or a call for communication to the power supply controller 19 or the EC 20 occurs during the updating of the firmware, it is possible that the contents of the firmware will be damaged. However, after an OS shutdown procedure is completed, all active task are closed. Device drivers, for example, perform a terminating process and complete writing any data to memory. If it is necessary to save the condition of the OS, the OS characteristic data are stored in a hard drive during the OS shutdown. In relation to FIG. 1, the shutdown process effectively shuts down operation of the communication I/F 17, the display controller 14, LCD 142, external CRT 143, and I/O controller 16. Thus, the firmware can be updated in a reliable manner by executing, as in the present embodiment, the updating process after the operating system has completed execution of the shutdown process.

The host-PCI bridge 12 is a bridge device that bidirectionally connects the CPU bus 1 to the PCI bus 2, and contains a memory controller configured to control the access to the main memory 13. The main memory 13 stores the operating system, application programs/drivers to be processed, and user data created by the application programs/drivers. The display controller 14 displays image data, drawn in an video memory (VRAM) 141, on one of or both of an LCD 142 provided in the computer main body and an external CRT 143.

The PCI-ISA bridge 15 is a bridge device that bidirectionally connects the PCI bus 2 to the ISA bus 3, and can operate as the bus master of the PCI bus 2. The PCI-ISA bridge 15 contains a function of controlling various I/O devices and memories on the ISA bus 3 under the control of the CPU 11. The rewriting of the flash BIOS-ROM 18 is executed by writing new BIOS image data into it after its contents are erased.

The I/O controller 16 can also control a DVD drive or a CD-ROM drive.

The communication interface 17 communicates with a computer on a network such as the Internet. The communication interface 17 is realized by a modem or a LAN card. To update the firmware, the communication interface 17 downloads new firmware data, having its version upgraded, from a WEB (World Wide Web) server on the Internet. The downloaded firmware data is stored in an HDD 161.

The flash BIOS-ROM 18 stores the system BIOS as aforementioned. To enable the BIOS to be updated using software, the flash BIOS-ROM 18 is realized by a flash memory (flash EEPROM) as an electrically programmable nonvolatile memory. The system BIOS is comprised of a POST (Power-On Self Test) routine executed when booting or rebooting the computer system, device drivers configured to control various I/O devices, and a BIOS setup routine configured to set up the system environment. The system BIOS is used to directly control the hardware in the computer system. In this embodiment, the flash BIOS-ROM 18 also stores the aforementioned firmware-updating program.

The power supply controller 19 controls the power-on and -off of the computer system. The power supply controller 19 is joined with the EC 20 to monitor the on/off state of a power supply switch, the residual capacity of a battery, the connection/disconnection state of an AC adaptor, and the on/off state of a display panel open/close detection switch. The power supply controller 19 and the EC 20 are each constructed by a 1-chip microcomputer that contains a microcomputer unit (MPU), and respectively contain firmware ROMs 191 and 201 that store programs to be executed by the respective MPUs. Like the flash BIOS-ROM 18, the firmware ROMs 191 and 201 are formed of respective electrically programmable nonvolatile memories.

(Software Structure Configured to Update BIOS)

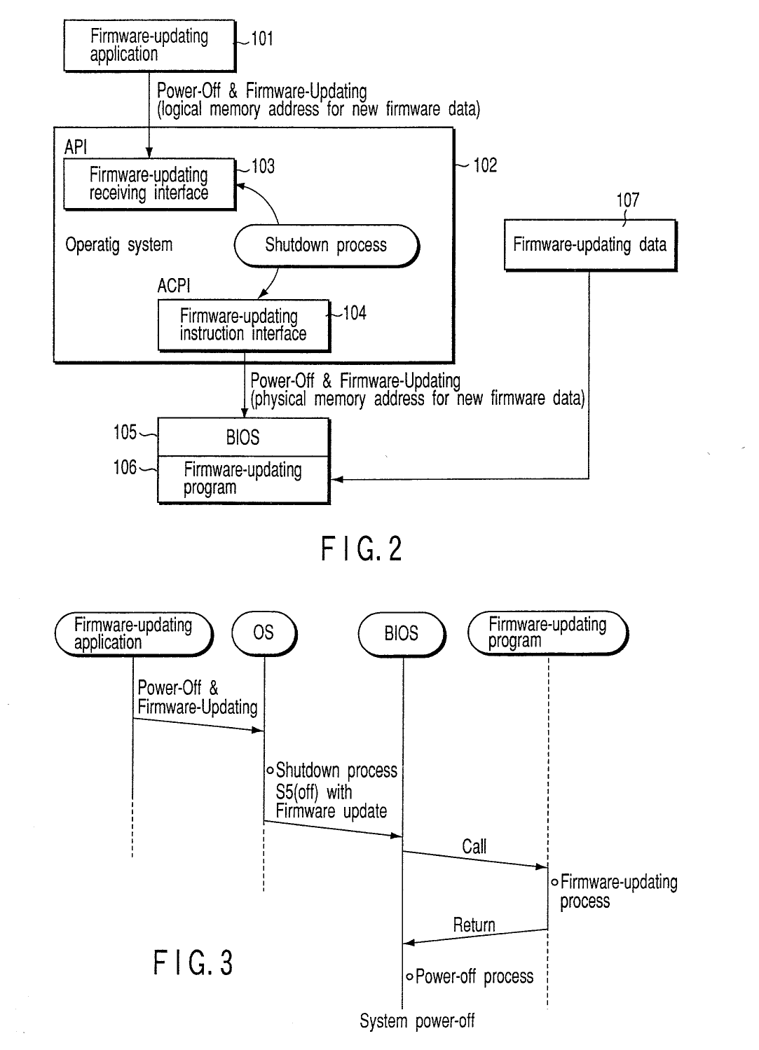

Referring now to FIG. 2, a description will be given of a software structure configured to realize the firmware-updating method of the embodiment.

As described above, the embodiment employs a firmware-updating application 101 and a firmware-updating program 106 as software used to rewrite the firmware. The firmware-updating application 101 is an application program providing a user interface that enables the user to, for example, issue an instruction to update the firmware. The firmware-updating application 101 includes (1) a function of downloading new firmware data from a WEB server, and (2) a function of issuing, to an operating system 102, a shutdown request including a request for firmware updating, i.e. a request for “Power-Off & Firmware-Updating”.

The “Power-Off & Firmware-Updating” request is a shutdown request for making the operating system execute the shutdown process, and making the operating system issue, after the completion of the shutdown process, an event that indicates the completion of the shutdown process. This request is issued from the firmware-updating application 101 to the operating system 102 via a firmware-updating receiving interface 103 incorporated in the operating system 102 as an API (Application Program Interface). Upon receiving the “Power-Off & Firmware-Updating” request by the firmware-updating receiving interface 103, the operating system 102 starts the shutdown process.

A logical memory address indicative of the location of new firmware data in the main memory 13 is supplied as a parameter of the “Power-Off & Firmware-Updating” request to the firmware-updating receiving interface 103 from the firmware-updating application 101. The logical memory address is a virtual memory address managed by a virtual address management mechanism provided by the operating system 102. Specifically, the firmware-updating application 101 acquires the new firmware data from the WEB server or the hard disk drive 161, and loads it into a memory area assigned to the firmware-updating application 101. Since, however, the memory area of the firmware-updating application 101 is managed by the virtual address management mechanism provided by the operating system 102, it is only the logical memory address that the firmware-updating application 101 recognizes. Accordingly, the location of the new firmware data in the main memory 13 is reported as the logical memory address to the operating system 102.

Further, the operating system 102 also incorporates a firmware-updating instruction interface 104 as an ACPI (Advanced Configuration and Power Interface). The ACPI is an interface configured to issue a power management event to a BIOS 105 in order to automatically power off (a power-off state includes a sleep state such as a suspend state or a hibernation state, etc.) or reboot the computer after the operating system 102 executes the shutdown process. After the operating system 102 has started the shutdown process in response to the “Power-Off & Firmware-Updating” request, and completed the shutdown process, the firmware-updating instruction interface 104 issues a power management event (Power-Off & Firmware-Updating) as an instruction to update the firmware and power off (or reboot) the system. After issuing the “Power-Off & Firmware-Updating” power management event, the operating system 102 stops all operations thereof. The “Power-Off & Firmware-Updating” power management event includes, as a parameter, a physical memory address indicative of the location of new firmware data in the main memory 13. This physical memory address is obtained by translating the aforementioned logical memory address using the virtual address management mechanism of the operating system 102. The report of the location of the new firmware data using the physical memory address enables the data to be read from the main memory 13 even after the operating system 102 stops.

The BIOS 105 includes an interface configured to receive a power management event from the operating system 102 via the ACPI. This interface is realized by, for example, an I/O trap as described below. When the operating system 102 has written, into a predetermined I/O register, data indicative of a power management event, a hardware interrupt signal is supplied to the CPU 11. Upon receiving this hardware interrupt signal, the CPU 11 starts the execution of the BIOS 105. The contents of the BIOS-ROM 18 are pre-copied into the main memory 13, and hence the BIOS 105 is executed using the main memory 13. Upon receiving the “Power-Off & Firmware-Updating” power management event, the BIOS 105 calls for the firmware-updating program 106 before powering off or rebooting the system, thereby causing the program to execute firmware updating based on new firmware data. The firmware-updating program 106 is also pre-copied in the main memory 13, and hence is executed using the main memory 13.

(The flow of the Firmware Updating Process)

Referring then to FIG. 3, a description will be given of a process executed for the firmware updating.

To update the firmware, at first, the user activates the firmware-updating application 101 while the operating system 102 is operating, thereby designating location information such as the file name of new firmware data, and instructing the firmware-updating application 101 to update the firmware. The firmware-updating application 101 issues, to the operating system 102, the logical memory address of the new firmware data and a “Power-Off & Firmware-Updating” request.

The operating system 102 starts a shutdown process, and issues a “Power-Off & Firmware-Updating” power management event after the completion of the shutdown process, thereby stopping operating. The “Power-Off & Firmware-Updating” power management event can be defined as an extended specification for the ACPI. In the ACPI specifications, states S0-S5 are defined as the system states. State S0 indicates the working state (i.e. a state in which the system is powered on and the software in it is running), and state S5 indicates the OFF state (i.e. a state in which the system is powered off and no software is running). Further, states S1-S4 indicate intermediate states between the working state and the OFF state, i.e. sleep states (the context of the software immediately before any one of the sleep states is saved, and the software is stopped in the sleep state). The amount of power consumed in these system states is represented by S0>S1>S2>S3>S4>S5. The “Power-Off & Firmware-Updating” power management event can be defined as an event that instructs the system to be shifted to a new extended system state “S5 with Firmware Update”.

When the “Power-Off & Firmware-Updating” power management event has occurred, the BIOS 105 (ACPI BIOS) is activated to thereby call for the firmware-updating program 106. The firmware-updating program 106 executes a firmware-updating process in which the to-be-updated contents of the nonvolatile memory are replaced with new firmware data 107. After finishing the firmware-updating process, the firmware-updating program 106 returns control to the BIOS 105. The BIOS 105 powers off or reboots the system in accordance with the “Power-Off & Firmware-Updating” power management event.

As described above, the embodiment uses the mechanism in which (1) a request for “Power-Off & Firmware-Updating”, which includes data concerning the location of new firmware data, is issued from the firmware-updating application 101 to the operating system, thereby making the operating system execute the shutdown process, and in which (2) the firmware-updating process is executed in response to the “Power-Off & Firmware-Updating” power management event supplied from the operating system. This mechanism enables the firmware to be updated safely simply by storing new firmware data in any voluntarily selected storage such as a hard disk.

The above-described structure may be modified such that the BIOS 105 executes a pre-process for a power-off or reboot process before calling for the firmware-updating program 106, and then calls for the firmware-updating program 106 to execute the firmware-updating process. In the pre-process, it is checked, for example, whether or not data that is not yet saved remains, and if it remains, a process, in which, for example, it is written into the hard disk drive 161, is executed. The power-off or reboot process is carried out by the BIOS 105 after the firmware-updating process by the firmware-updating program 106, thereby actually powering off or rebooting the system.

Furthermore, the firmware-updating program 106 may execute the power-off or rebooting process, instead of returning control to the BIOS 105 after the firmware-updating process.

(Firmware-Updating Application)

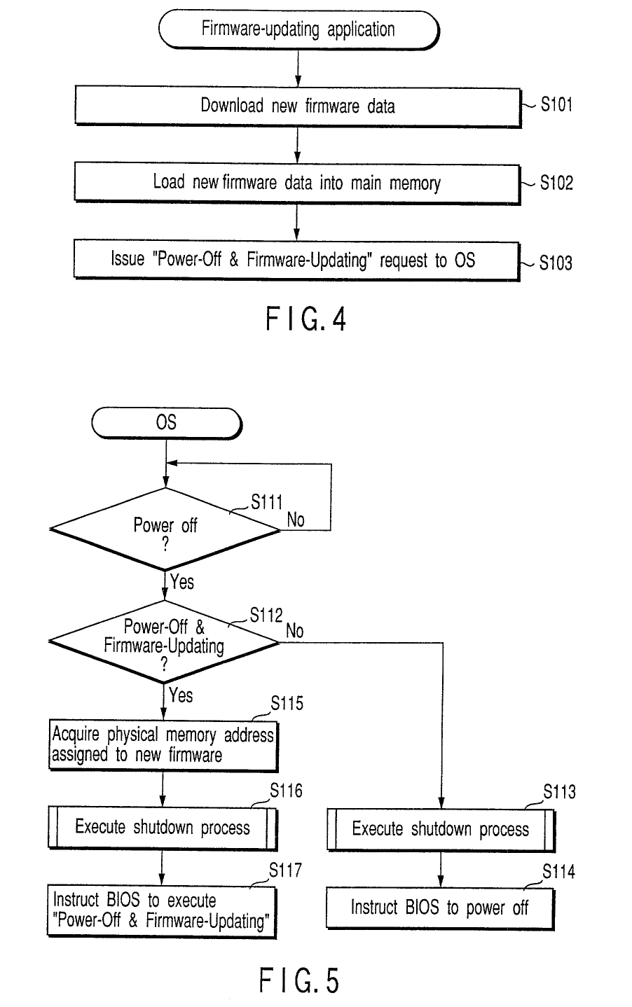

The flowchart of FIG. 4 illustrates the procedure of the firmware-updating application.

The firmware-updating application 101 first downloads new firmware data from, for example, a WEB server in accordance with a user's operation (step S101). Subsequently, upon receiving, from the user, location information such as the file name (pass information) of the downloaded new firmware data, the firmware-updating application 101 shifts the new firmware data (the image data of new firmware data) from a storage area of the system, designated by the location information, to a memory area of the main memory 13 dedicated to the new firmware data (step S102). After that, the firmware-updating application 101 issues, to the operating system 102, a request for “Power-Off & Firmware-Updating” as well as the logical memory address of the new firmware data, thereby instructing the operating system 102 to execute the shutdown process for firmware updating (step S103).

(Operating System)

FIG. 5 illustrates the procedure of the operating system.

Upon receiving a request for power off, i.e. for shutdown (if the answer at step S111 is YES), the operating system 102 first determines whether the shutdown request is for “Power-Off & Firmware-Updating” or for usual power off (step S112). If it is for usual power off and not for “Power-Off & Firmware-Updating”, the operating system 102 executes the shutdown process (step S113), instructs the BIOS to power off the system (S5) after the completion of the shutdown process, and finishes its operation (step S114).

On the other hand, if the shutdown request is for “Power-Off & Firmware-Updating”, the operating system 102 translates a logical memory address designated in the request for “Power-Off & Firmware-Updating” into a physical memory address, thereby acquiring the physical memory address assigned to the new firmware data (step S115). Subsequently, the operating system 102 executes the shutdown process (step S116). After the completion of the shutdown process, the operating system 102 instructs the BIOS 105 to transfer to “Power-Off & Firmware-Updating” (S5 with Firmware Update), supplies the BIOS 105 with the physical memory address assigned to the new firmware data, and finishes its operation (step S117). (BIOS).

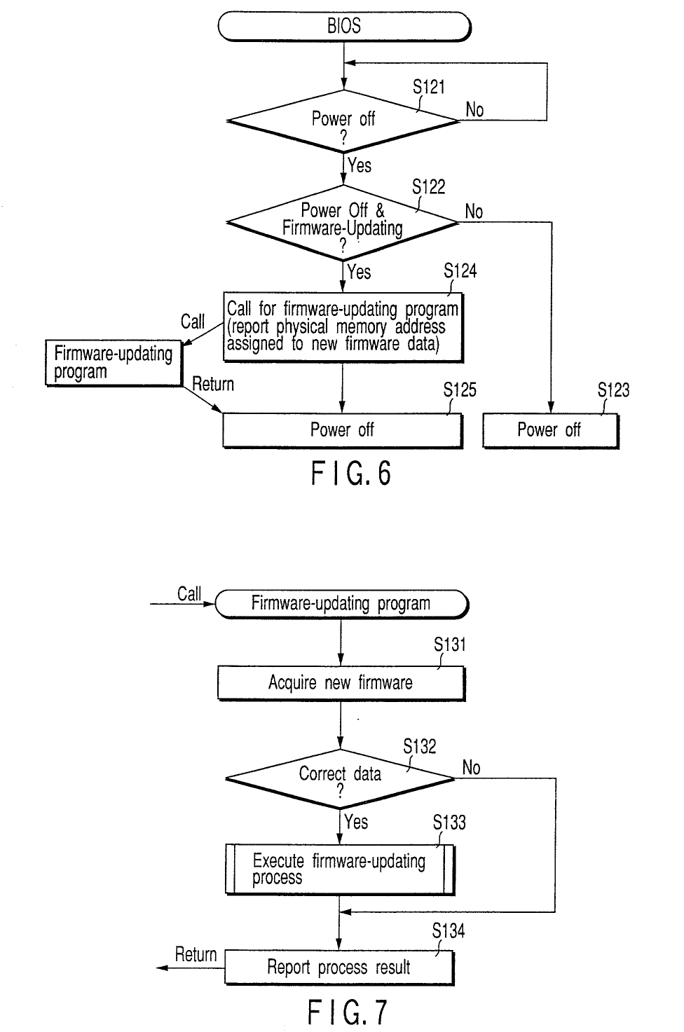

FIG. 6 illustrates the procedure of the BIOS.

Upon receiving a power management event for power off from the operating system 102 (if the answer at step S121 is YES), the BIOS 105 determines whether the power management event is for “Power-Off & Firmware-Updating” or for usual power off (step S122). If it is for usual power off (S5), the BIOS 105 powers off the system using the power supply controller 19 (step S123).

If, on the other hand, the power management event is for “Power-Off & Firmware-Updating” (S5 with Firmware Update), the BIOS 105 calls for the firmware-updating program 106 with the system kept ON, and causes the firmware-updating program 106 to execute a firmware-updating process (step S124). At this time, the BIOS 105 supplies the firmware-updating program 106 with the physical memory address assigned to the new firmware data. After completing the firmware-updating process, the firmware-updating program 106 returns control to the BIOS 105. The BIOS 105 powers off the system using the power supply controller 19, or causes the power supply controller 19 to generate a reset signal for rebooting the system (step S125).

(Firmware-Updating Program)

FIG. 7 illustrates the procedure of the firmware-updating program 106.

The firmware-updating program 106 acquires the new firmware data from a memory area designated by the physical memory address supplied from the BIOS 105 (step S131), and determines whether or not the new firmware data is correct (step S132). This correctness check is executed using, for example, information recorded in the header section of the file of the new firmware data. For example, ID information used to recognize a computer corresponding to firmware data is added to the header section of the file of the new firmware data. The firmware-updating program 106 determines, on the basis of the ID information, whether or not the new firmware data corresponds to the present computer system.

If no problem is found in the correctness check, the firmware-updating program 106 executes a firmware-updating process in which the contents of the nonvolatile memory are replaced with the new firmware data (step S133). If this process is finished normally, a value indicative of the normal finish is supplied as a return value to the BIOS 105 (step S134). On the other hand, if the new firmware data is not correct, the firmware-updating program 106 supplies the BIOS 105 with data indicating that the new firmware data is not correct, without executing the firmware-updating process (step S134). In this case, the BIOS 105 displays, for example, an error message.

In the firmware-updating process at the step S133, rewriting of the flash BIOS-ROM 18 is executed (data stored in the flash BIOS-ROM 18 is erased and new data is written into it). Since the operating system 102 has already executed shutdown process, no software access to the flash BIOS-ROM 18 occurs during the firmware-updating process.

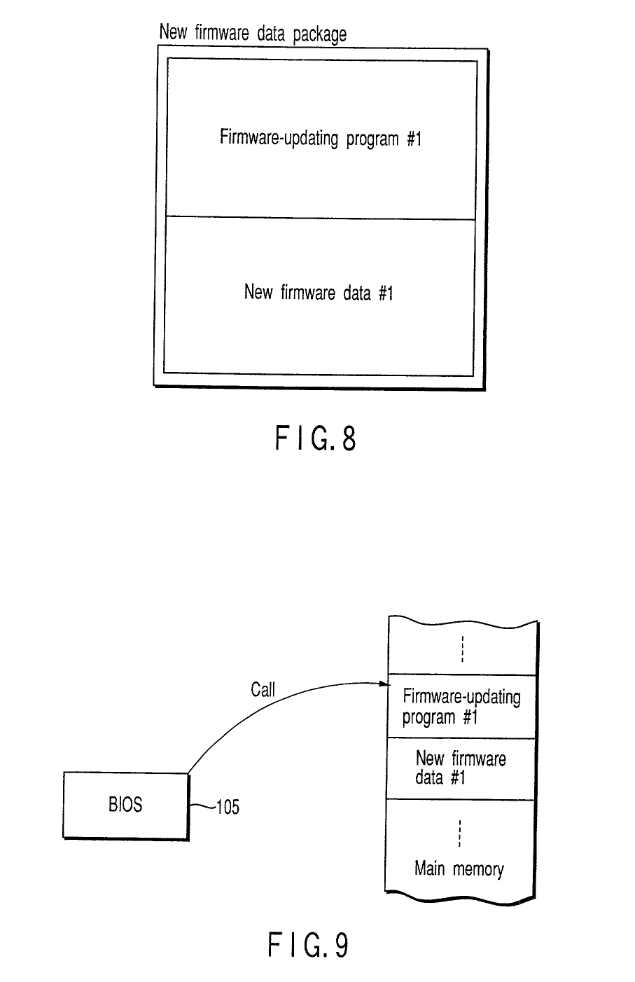

Although in the above-described embodiment, the firmware-updating program 106 is prestored in the BIOS-ROM 18, this structure may be modified such that a new firmware package as shown in FIG. 8, which includes new firmware data and a corresponding firmware-updating program, is downloaded from, for example, a WEB server, and the BIOS 105 activates the firmware-updating program contained in the downloaded new firmware package.

In this case, the firmware-updating program and the new firmware data contained in the new firmware package are loaded into the main memory 103 by the firmware-updating application 101, and the logical memory address that indicates the position of the data in the main memory 13 is reported to the operating system 102. It is not necessary for the operating system 102 to recognize whether only the new firmware data or both the new firmware data and the firmware-updating program are loaded in the main memory 13.

It is preferable that a structure such as the data size of each of the new firmware data and the firmware-updating program, or the positional relationship therebetween is defined beforehand. In this case, as is shown in FIG. 9, the BIOS 105 can activate the firmware-updating program by executing a FAR call command to a physical memory address designed in a “Power-Off & Firmware-Updating” power management event, or to a memory address value obtained by adding a predetermined offset value to the physical memory address.

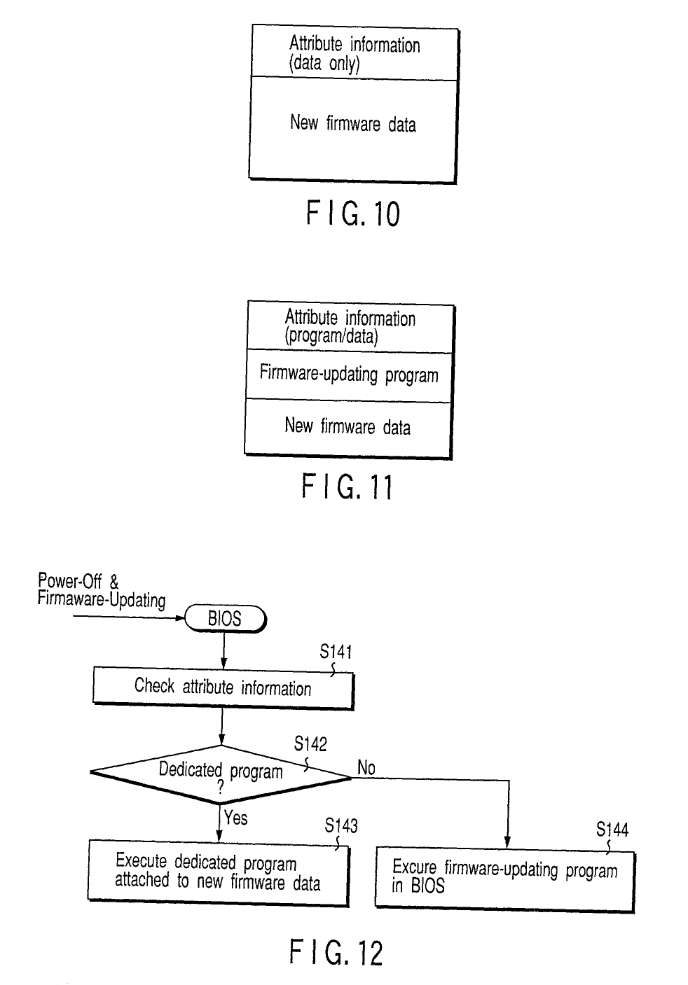

Moreover, it is preferable that, as shown in FIGS. 10 and 11, attribute information is attached to the leading portion of the new firmware package, so as to enable the recognition as to the type of to-be-rewritten firmware, or as to whether the package includes only new firmware data or both new firmware data and a firmware-updating program.

In this case, as shown in FIG. 12, the BIOS 105 reads the attribute information from the memory area designed by the physical memory address reported by the “Power-Off & Firmware-Updating” power management event, thereby determining whether the new firmware data is provided with a dedicated firmware-updating program or with no dedicated firmware-updating program (steps S141 and S142). If the new firmware data is provided with a dedicated firmware-updating program, the BIOS 105 activates the dedicated firmware-updating program (step S143). If the new firmware data is provided with no dedicated firmware-updating program, the BIOS 105 activates a firmware-updating program stored in the BIOS-ROM 18 (step S144).

If firmware packages each containing a firmware-updating program and new firmware data for each to-be-rewritten firmware item are prepared, and the firmware-updating program is activated, any to-be-rewritten firmware item (whether it is a BIOS-ROM or a firmware ROM) can be rewritten without considering its type. Further, when using a firmware-updating program stored in the BIOS-ROM 18, a plurality of firmware-updating programs corresponding to to-be-rewritten firmware items (the BIOS-ROM, the firmware ROM) may be stored in the BIOS-ROM 18. In this case, the one of the programs, which corresponds to a to-be-rewritten target designated by the aforementioned attribute information, is activated.

As described above, in the embodiment, an instruction to update firmware is issued after the completion of a shutdown process, thereby updating the firmware with the operating system stopped. Accordingly, firmware such as the BIOS or any program to be executed by an MPU in a controller can be updated safely, with the operating system and the other programs stopped.

Moreover, since a new mechanism is employed in which a firmware-updating process is started in response to a report issued from the operating system after the completion of the shutdown process by the operating system, the firmware-updating process can be started after the operating system has completed the shutdown process. When issuing the instruction from the operating system to update the firmware, the instruction is attached to a power management event, which is issued from the operating system to automatically power off or reboot the information-processing apparatus, when the operating system has completed its shutdown process. As a result, the information-processing apparatus can be kept in the ON state even if the operating system has executed the shutdown process and shifted into a power-off enabling state, and during this period, the firmware-updating process is executed. After the completion of the firmware-updating process, the information-processing apparatus is powered off or rebooted.

The BIOS, OS, firmware-updating application, firmware-updating program can be stored in a computer-readable storage medium, individually or in combination.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. An information-processing apparatus comprising:
a nonvolatile memory device configured to store firmware;
first means for issuing an instruction to an operating system to make the operating system execute a shutdown process, and to update the firmware, stored in the nonvolatile memory device, after the operating system has completed the shutdown process; and
second means, responsive to the instruction to update the firmware, for updating the firmware after the operating system has completed the shutdown process.

2. The information-processing apparatus according to claim 1, wherein the first means includes means for issuing, to the operating system, a shutdown request containing a request for updating the firmware, thereby making the operating system issue the instruction to update the firmware after the operating system has completed the shutdown process.

3. The information-processing apparatus according to claim 2, wherein;
the instruction to update the firmware supplied from the operating system is included in a power management event, which is issued from the operating system to power off or reboot the information-processing apparatus; and
the second means includes means for powering off or rebooting the information-processing apparatus in response to the power management event, after the firmware has been updated.

4. The information-processing apparatus according to claim 2, wherein;
the shutdown request issuing means includes means for reporting, to the operating system, first address information indicative of a storage location of new firmware to be written into the nonvolatile memory device; and
the second means includes means for reading the new firmware from a storage location indicated by second address information that is included in the instruction to update the firmware supplied from the operating system, and writing the read new firmware into the nonvolatile memory device.

5. The information-processing apparatus according to claim 4, wherein;
the first address information reported to the operating system corresponds to a logical memory address; and
the second address information included in the instruction to update the firmware supplied from the operating system corresponds to a physical memory address.

6. The information-processing apparatus according to claim 2, wherein;
the shutdown request issuing means includes means for reporting, to the operating system, first address information indicative of a storage location of an updating information package that contains new firmware to be written into the nonvolatile memory device and an updating-process program used to write the new firmware into the nonvolatile memory device; and
the second means includes means for calling for the updating-process program contained in the updating information package stored in a storage location that is indicated by second address information included in the instruction to update the firmware supplied from the operating system, thereby causing the updating-process program to execute an updating process for writing the new firmware of the updating information package into the nonvolatile memory device.

7. The information-processing apparatus according to claim 6, wherein;
the first address information reported to the operating system corresponds to a logical memory address; and
the second address information included in the instruction to update the firmware supplied from the operating system corresponds to a physical memory address.

8. The information-processing apparatus according to claim 1, wherein the firmware stored in the nonvolatile memory device is a BIOS program configured to control hardware of the information-processing apparatus.

9. The information-processing apparatus according to claim 1, wherein the firmware stored in the nonvolatile memory device is a program to be executed by an MPU in a controller that is incorporated in the information-processing apparatus.

10. An information-processing apparatus capable of executing various types of programs, comprising:
a nonvolatile memory device configured to store firmware;
first means for issuing, to an operating system, a shutdown request containing a request for updating the firmware, thereby making the operating system execute a shutdown process, and also causing the operating system to issue, after the operating system has completed the shutdown process, a power management event including an instruction to update the firmware stored in the nonvolatile memory device and to power off or reboot the information-processing apparatus; and
second means, responsive to the power management event issued from the operating system, for executing a firmware-updating process to update the firmware stored in the nonvolatile memory device thereby providing new firmware, and then powering off or rebooting the information-processing apparatus.

11. The information-processing apparatus according to claim 10, wherein;
the first means includes means for reporting, to the operating system, first address information indicative of a storage location of new firmware to be written into the nonvolatile memory device; and
the second means includes means for reading new firmware from a storage location indicated by second address information that is included in the power management event issued from the operating system, and writing the read new firmware into the nonvolatile memory device.

12. The information-processing apparatus according to claim 10, wherein;
the first means includes means for reporting, to the operating system, first address information indicative of a storage location of an updating information package that contains new firmware to be written into the nonvolatile memory device and an updating-process program used to write the new firmware into the nonvolatile memory device; and
the second means includes means for calling for the updating-process program contained in the updating information package stored in a storage location that is indicated by second address information included in the power management event from the operating system, thereby causing the updating-process program to execute an updating process for writing the new firmware of the updating information package into the nonvolatile memory device.

13. An information-processing apparatus capable of executing various types of programs, comprising:
a nonvolatile memory device configured to store firmware;
firmware-updating means for updating the firmware stored in the nonvolatile memory device; and
means for instructing, when updating the firmware, the firmware-updating means to update the firmware, using a power management event that is issued from an operating system being executed in the information-processing apparatus, the power management event causing initiation and completion of a shutdown process, then an updating of the firmware and lastly a powering off or rebooting of the information processing system.

14. The information processing apparatus as recited in claim 13, wherein said shutdown process closes down all active task including closing device drivers forming part of said information processing apparatus.

15. The information processing apparatus as recited in claim 14, wherein said information processing apparatus includes a communication interface, a display controller, a display and an I/O controller and said shutdown process closes down said communication interface, said display controller, said display and said I/O controller.

16. The information processing apparatus as recited in claim 15, wherein said information processing apparatus includes a central processing system, a main memory, a flash ROM, and power supply controller, and said shutdown process does not shut down said central processing system, said main memory, said flash ROM, and said power supply controller.

17. A firmware-updating method of updating firmware executed in an information-processing apparatus, comprising:
making an operating system execute a shutdown process, and issuing an instruction to update firmware stored in a nonvolatile memory device incorporated in the information-processing apparatus, after the operating system has completed the shutdown process; and
updating the firmware after the operating system has completed the shutdown process, in response to the instruction to update the firmware.

18. The firmware-updating method according to claim 17, wherein the issuing the instruction to update the firmware includes
issuing a shutdown request containing a request for updating the firmware, thereby making the operating system issue the instruction to update the firmware after the operating system has completed the shutdown process.

19. The firmware-updating method according to claim 18, wherein;
the instruction to update the firmware is included in a power management event, which is issued from the operating system to power off or reboot the information-processing apparatus, when the operating system has completed the shutdown process; and
the updating includes
powering off or rebooting the information-processing apparatus in accordance with the power management event, after the firmware has been updated.

20. The firmware-updating method according to claim 18, wherein;
the issuing the shutdown request includes reporting, to the operating system, first address information indicative of a storage location of new firmware to be written into the nonvolatile memory device; and
the updating includes
reading the new firmware from a storage location indicated by second address information that is included in the instruction to update the firmware supplied from the operating system, and writing the read new firmware into the nonvolatile memory device.

21. The firmware-updating method according to claim 18, wherein;
the issuing the shutdown request includes
reporting, to the operating system, first address information indicative of a storage location of updating information package that contains new firmware to be written into the nonvolatile memory device and an updating-process program used to write the new firmware into the nonvolatile memory device; and
the updating includes
calling for the updating-process program contained in the updating information package stored in a storage location that is indicated by second address information included in the instruction to update the firmware, thereby causing the updating-process program to execute an updating process for writing the new firmware of the updating information package into the nonvolatile memory device.

22. A firmware-updating method of updating firmware executed in an information-processing apparatus, comprising:
issuing, to an operating system, a shutdown request containing a request for updating the firmware stored in a nonvolatile memory device provided in the information-processing apparatus, thereby making the operating system execute a shutdown process, and also causing the operating system to issue, after the operating system has completed the shutdown process, a power management event as an instruction to update the firmware and to power off or reboot the information-processing apparatus; and
executing a firmware-updating process to update the firmware into new firmware, in response to the power management event issued from the operating system when the operating system has completed the shutdown process, and then powering off or rebooting the information-processing apparatus.

23. A firmware-updating method of updating firmware executed in an information-processing apparatus, comprising:
issuing, from an application program executed on an operating system to the operating system, a shutdown request containing a request for updating firmware stored in a nonvolatile memory device provided in the information-processing apparatus;
activating a firmware-updating program operable without the operating system, in response to a power management event as an instruction to update the firmware and to power off or reboot the information-processing apparatus, which is issued from the operating system after the operating system has completed a shutdown process; and
powering off or rebooting the information-processing apparatus after the firmware is updated using the firmware-updating program.

24. A program stored in a storage medium and operable, when executed on a computer to cause said computer to execute a firmware-updating process for updating of firmware in the computer, said program causing said computer to perform the steps of:
receiving a firmware-updating request for updating the firmware, which is issued from an operating system when the operating system has executed a shutdown process on the computer; and
executing a firmware-updating process for updating, into new firmware, the firmware stored in a nonvolatile memory device provided in the computer, after the operating system has completed the shutdown process.

25. The program according to claim 24, wherein the firmware-updating request is included in a power management event issued, from the operating system when the operating system has completed the shutdown process, to power off or reboot the computer, and the program further operative to cause the computer to power off or reboot after completing the firmware-updating process.
